(19) United States
(12) Patent Application Publication
(10) Pub. No.: US 2007/0079709 A1
(43) Pub. Date: Apr. 12, 2007

(54) Adjustable skewer gripping device

(76) Inventors: John Graham Giblin, Ocean Reef (AU); Scott John Hantke, Morley (AU)

Correspondence Address: Kenneth L Mitchell;Woodling Krost & Rust, 9213 Chillicothe Road, Kirtland, OH, 44094, US

(21) Appl. No.: 10/567,519

(22) PCT Filed: Apr. 29, 2005
(86) PCT No.: PCT/AU05/00602

§ 371 Date: Jan. 2, 2007

(30) Foreign Application Priority Data
Apr. 30, 2004 (AU) 2004902258

(51) Int. Cl. A47J 37/04

(52) U.S. Cl. 99/419

(57) ABSTRACT

A skewer gripping device (20) for use with a skewer (10) has a food engaging surface (24) and a locating portion (32). The locating portion (32) has a clamping screw (36) associated therewith. In use, food is placed on the skewer (10) between two gripping devices (20), which clamp the food in position. The gripping devices (20) act to hold the skewer (10) away from a hot surface, and thus prevent contact of the food and the hot surface.

### FIELD OF THE INVENTION

The present invention relates to a device used in relation to skewers during cooking.

### BACKGROUND TO THE INVENTION

It is known to thread foodstuffs such as meat and vegetables onto skewers for cooking. Often, such cooking is done by placing the threaded skewer onto a hot surface such as a grill plate or a griddle.

When cooking foodstuffs on a skewer using traditional methods, the primary mode of heat transfer is via conduction from the hot surface to the foodstuffs. This results in the portion of the foodstuffs in contact with the hot surface cooking much more quickly than the rest of the foodstuffs. As a result, it is difficult to avoid charring of the foodstuffs.

Foodstuffs are rarely threaded onto skewers in a perfectly balanced fashion. As a result, a threaded skewer often has a tendency to roll towards a most stable position. It is thus extremely difficult to achieve a uniform cooking about the skewer. Where the foodstuff is only loosely threaded on the skewer, it can have a tendency to revolve relative to the skewer, exacerbating this problem.

Further problems are encountered during the use of skewers by a tendency for food in contact with the hot surface to stick to the hot surface, thus causing damage to the food.

The present invention attempts to overcome at least in part some of the aforementioned disadvantages of previous methods of cooking skewered food.

### SUMMARY OF THE INVENTION

In accordance with one aspect of the present invention there is provided a skewer gripping device for use with a skewer, the gripping device comprising a food engaging surface, an outer periphery and a gripping means, characterised in that the gripping means is adjustable between a first configuration in which the skewer gripping device can move relative to the skewer and a second configuration in which the skewer gripping device is fixed relative to the skewer, and wherein, in use, the outer periphery of the skewer gripping device extends substantially about the skewer, providing a minimum distance by which the skewer is spaced from a surface on which it rests.

In accordance with a second aspect of the present invention there is provided a method of arranging foodstuffs on a skewer, the method including locating a first gripping device on a skewer adjacent a first end of the skewer, the first gripping device having a food engaging surface and an outer periphery, such that the food engaging surface is oriented towards a second end of the skewer; introducing foodstuffs onto the second end of the skewer; and locating a second gripping device on the skewer adjacent the second end, the second gripping device having a food engaging surface and an outer periphery, such that the food engaging surface is oriented towards the first end of the skewer; whereby a clamping force is provided between the respective food engaging surfaces to maintain the foodstuffs in position relative to the skewer.

### BRIEF DESCRIPTION OF THE DRAWINGS

The present invention will now be described, by way of example, with reference to the accompanying drawings, in which:

FIG. 1 is a skewer having two skewer gripping devices in accordance with the present invention, shown in an assembled state; and

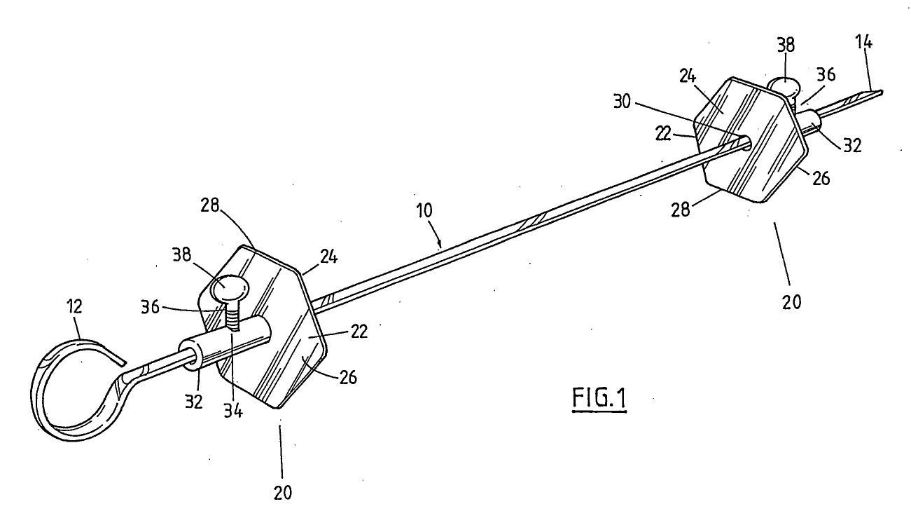

FIG. 2 is the skewer and gripping devices of FIG. 1 shown in a disassembled state.

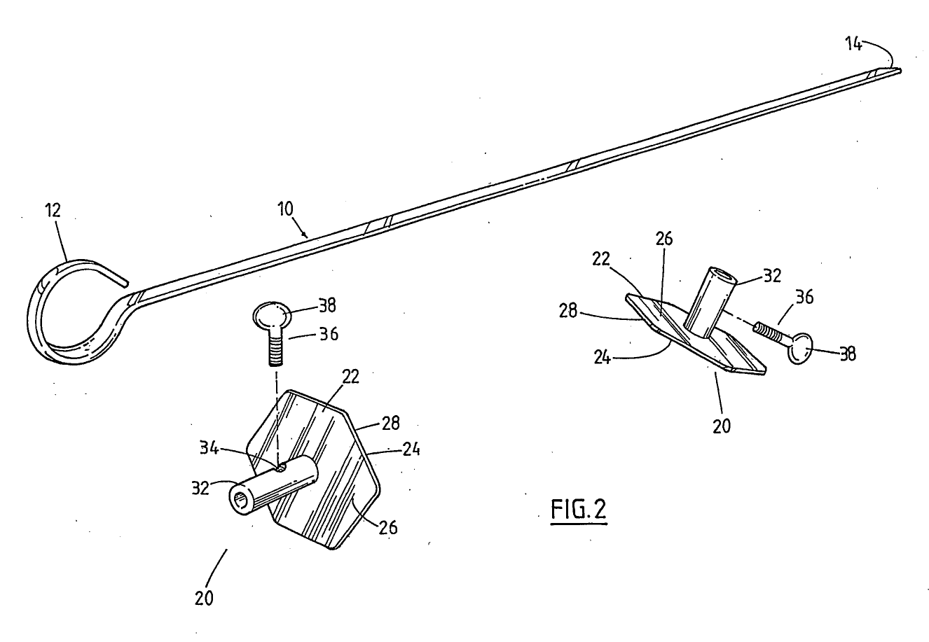

### DESCRIPTION OF PREFERRED EMBODIMENTS

Referring to the Figures, there is shown a food skewer 10 having a first end 12 and a second end 14. The skewer 10 is looped at the first end 12 to form a handle. The skewer 10 is pointed at the second end 14 to allow for the insertion of food thereon. Two skewer gripping devices 20 are mounted on the skewer 10.

Each skewer gripping device 20 includes a substantially hexagonal plate 22. The hexagonal plate 22 is substantially perpendicular to a longitudinal direction of the skewer 10. The hexagonal plate 22 has a front face 24 which serves, in use, as a food engaging surface and a rear face 26. The hexagonal plate 22 has an outer periphery in the form of an outer edge 28. The hexagonal plate 22 has a centrally located aperture 30

A substantially cylindrical locating portion 32 extends outwardly from the central aperture 30 of the hexagonal plate 22, away from the rear face 26 in a direction perpendicular to the plate 22. The locating portion 32 is hollow, and communicates with the central aperture 30. The locating portion 32 and central aperture 30 are sized so as to allow the skewer 10 to slide within the location portion 30.

The locating portion 32 includes an internally threaded radial aperture 34 located along its length. An externally threaded clamping screw 36 having a bulbous head 38 is receivable within the aperture 34. The action of the clamping screw 36 within the locating portion 32 comprises a gripping means against the skewer 10.

The gripping means has a first configuration in which the clamping screw 36 is not tightened within the aperture 34, and does not bear against the skewer 10. When the gripping means is in the first configuration, the locating portion 32 and thus the gripping device 20 is able to readily slide along the skewer 10.

The gripping means has a second configuration in which the clamping screw 36 is tightened within the aperture 34, and bears against the skewer 10. In this configuration, the clamping screw 36 provides a frictional force against the skewer 10 and prevents sliding of the gripping device 20 along the skewer 10. It will be appreciated that a user can tighten the clamping screw 36, and thus adjust the gripping means between the first and second configurations, using the bulbous head 38.

In use, a first gripping device 20 is located on the skewer 10 by threading the second end 14 of the skewer 10 through the rear end of the locating portion 32. With the gripping means in the first position, the gripping device 20 can be slid up the skewer 10 to a desired location adjacent the first end 12 of the skewer 10. The screw 36 can then be tightened, fixing the gripping device 20 in location with its food engaging surface 24 oriented towards the second end 14 of the skewer 10.

Food stuffs can then be threaded onto the second end 14 of the skewer 10 in the usual manner. The first food item is threaded along the skewer until it bears against the food engaging surface 24. Subsequent foodstuffs are then added such that each food item is packed against adjacent food items.

When the skewer 10 is sufficiently loaded with food, a second gripping device 20 is introduced onto the skewer 10 in a similar fashion to the first gripping device 20. The second gripping device 20 is oriented such that its food engaging surface 24 is oriented towards the first end 12 of the skewer 10, and is thus in opposition to the food engaging surface 26 of the first gripping device 20.

The second gripping device 20 is pushed against the foodstuffs on the skewer until a sufficient clamping force is distributed along the foodstuffs between the opposed food engaging surfaces 24. The clamping screw 36 of the second gripping device 20 is then tightened to bring the gripping means into the second configuration.

It will be appreciated that the outer periphery 28 of each of the gripping devices 20 now extends about the skewer 10. When the skewer 10 is placed on a hot surface such as a grill plate, the outer peripheries 28 of the gripping devices 20 rest on the hot surface and the skewer 10 is displaced from the hot surface by at least the minimum radial extent of the gripping devices 20.

In a preferred mode of use, the foodstuffs placed on the skewer 10 do not extend past the minimum radial extent of the gripping devices 20. In use, therefore, foodstuffs placed on the skewer are spaced from the hot surface and are thus cooked by convection and radiation rather than conduction of heat.

In the preferred mode of use, the gripping devices 20 are arranged on the skewer 10 such that the outer peripheries 28 are aligned. In this way, the hexagonal peripheries 28 of the embodiment of the drawings provide 6 stable angular orientations for the skewer 10 in relation to the hot surface. The skewer 10 can thus be readily rotated through each of the angular orientations to provide even cooking of the food on the skewer 10. The clamping of the foodstuffs between the food engaging surfaces 24 prevents rotation of the food relative to the skewer 10.

Although the preferred embodiment of the drawings shows each periphery as hexagonal in shape, it will be appreciated that any shape could be used. Clearly, a regular polygonal shape is preferred.

Modifications and variations as would be apparent to a skilled addressee are deemed to be within the scope of the present invention.

1. A skewer gripping device for use with a skewer, the gripping device comprising a food engaging surface, an outer periphery and a gripping means, characterised in that the gripping means is adjustable between a first configuration in which the skewer gripping device can move relative to the skewer and a second configuration in which the skewer gripping device is fixed relative to the skewer, and wherein, in use, the outer periphery of the skewer gripping device extends substantially about the skewer, providing a minimum distance by which the skewer is spaced from a surface on which it rests.

2. A skewer gripping device as claimed in claim 1, characterised in that the food engaging surface is a front face of a plate.

3. A skewer gripping device as claimed in claim 2, characterised in that the outer periphery is the edge of the plate.

4. A skewer gripping device as claimed in claim 2, characterised in that the plate is regular polygonal in shape.

5. A skewer gripping device as claimed in claim 4, characterised in that the plate is hexagonal.

6. A skewer gripping device as claimed in claim 1, characterised in that the gripping means includes a hollow locating portion within which the skewer can slide when the gripping means is in the first configuration.

7. A skewer gripping device as claimed in claim 6, characterised in that the gripping means includes a clamping screw receivable within a threaded radial aperture of the locating portion.

8. A skewer gripping device as claimed in claim 7, characterised in that the clamping screw has a bulbous head.

9. A skewer including at least one skewer gripping device as claimed in claim 1.

10. A skewer including two skewer gripping devices as claimed in claim 1.

11. A method of arranging foodstuffs on a skewer, the method including locating a first gripping device on a skewer adjacent a first end of the skewer, the first gripping device having a food engaging surface and an outer periphery, such that the food engaging surface is oriented towards a second end of the skewer; introducing foodstuffs onto the second end of the skewer; and locating a second gripping device on the skewer adjacent the second end, the second gripping device having a food engaging surface and an outer periphery, such that the food engaging surface is oriented towards the first end of the skewer; whereby a clamping force is provided between the respective food engaging surfaces to maintain the foodstuffs in position relative to the skewer.

12. A method of arranging foodstuffs on a skewer as claimed in claim 11, characterised in that the outer peripheries of the first and second gripping devices extend around the skewer, and the foodstuffs do not extend past a minimum distance between the skewer and the outer peripheries.

13. A skewer gripping device as claimed in claim 3, characterised in that the plate is regular polygonal in shape.

14. A skewer gripping device as claimed in claim 13, characterised in that the plate is hexagonal.

15. A skewer gripping device as claimed in claim 2, characterised in that the gripping means includes a hollow locating portion within which the skewer can slide when the gripping means is in the first configuration.

16. A skewer gripping device as claimed in claim 15, characterised in that the gripping means includes a clamping screw receivable within a threaded radial aperture of the locating portion.

17. A skewer gripping device as claimed in claim 16, characterised in that the clamping screw has a bulbous head.

18. A skewer gripping device as claimed in claim 3 characterised in that the gripping means includes a hollow locating portion within which the skewer can slide when the gripping means is in the first configuration.

19. A skewer gripping device as claimed in claim 4 characterised in that the gripping means includes a hollow locating portion within which the skewer can slide when the gripping means is in the first configuration.

20. A skewer gripping device as claimed in claim 5 characterised in that the gripping means includes a hollow locating portion within which the skewer can slide when the gripping means is in the first configuration.
